(19) United States
(12) Patent Application Publication
(10) Pub. No.: US 2025/0178919 A1
(43) Pub. Date: Jun. 5, 2025

(54) PROCESS FOR THE PRODUCTION OF NANOCRYSTALS OF METAL CHALCOHALIDES

(71) Applicants: CONSIGLIO NAZIONALE DELLE RICERCHE, Roma (RM) (IT); FONDAZIONE ISTITUTO ITALIANO DI TECNOLOGIA, Genova (GE) (IT); UNIVERSITA DEL SALENTO, Lecce (LE) (IT); UNIVERSITA CATTOLICA DEL SACRO CUORE, Milano (MI) (IT)

(72) Inventors: Carlo GIANSANTE, Roma (RM) (IT); Danila QUARTA, Lecce (LE) (IT); Stefano TOSO, Genova (GE) (IT); Roberto GIANNUZZI, Roma (RM) (IT); Rocco CALIANDRO, Roma (RM) (IT); Anna MOLITERNI, Roma (RM) (IT); Cinzia GIANNINI, Roma (RM) (IT); Liberato MANNA, Genova (GE) (IT); Giuseppe GIGLI, Roma (RM) (IT)

(21) Appl. No.: 18/834,533

(22) PCT Filed: Jan. 31, 2023
(86) PCT No.: PCT/IB2023/050820

§ 371 Date: Jul. 30, 2024

(30) Foreign Application Priority Data
Jan. 31, 2022 (IT) 102022000001577

(51) Int. Cl. C01G 29/00; B82Y 40/00

(52) U.S. Cl. CPC C01G 29/006; B82Y 40/00; C01P 2002/01; C01P 2002/82; C01P 2002/84; C01P 2004/04; C01P 2004/17

(57) ABSTRACT

A process for the synthesis of nanocrystals of metal chalcohalides is disclosed, where M is a metal, E is a chalcogen and X is a halogen, starting from a salt of M. The process includes the following steps: a) a precursor of metal M is mixed with a surfactant in a solvent having a boiling point higher than 180° C.; b) the mixture obtained in previous step a) is heated, in order to dissolve the components, until it becomes clear; c) the solution is heated up under inert atmosphere at the desired temperature; d) chalcogen and halogen precursors in 0 a solvent having a boiling point higher than 180° C. are added through injection, while heating the solution obtained in steps a) to c); e) after the reaction time has elapsed, the product is quenched down to room temperature.

This invention refers to a process for the production of nanocrystals of metal chalcohalides, having the chemical formula MₙEₚX_{q}, where M is a metal, E is a chalcogen and X is a halogen. This invention also refers to nanocrystals of metal chalcohalides, produced through such a process and to uses of such nanocrystals in the electrochemical field.

Photoactive materials are becoming more and more important, especially since photovoltaic panels and similar structures have become of paramount importance. The production of such materials is often rather complicated and results in many pitfalls. In particular, the photoactive material should be coated or otherwise applied onto a carrier or base substrate. This application is by far not trivial to perform and can result in defects appearing on the surface, especially due to an inherent roughness of the coated material, what leads to bad performance or even to at least partial ineffectiveness of the photoactive material.

Another problem is to find photoactive materials which can be synthesised in a simple way, exhibiting good chemical, physical and mechanical properties at a reasonable cost and with no harm.

A number of inorganic materials have been tested for this purpose. In a first attempt, lead halide perovskites (AMX₃) exhibited good properties, possessing defect tolerance, resulting from the coupling between the s valence electrons with the occupied np orbitals of the non-metal elements within the semiconductor crystals produced. However, lead is toxic and a lot of effort has been performed since many years to reduce or even to eliminate it—for instance as it happened with tetraethyl-lead in petrol—as widely as possible, so as to avoid health problems.

Since the beginning of this process of substitution, bismuth has appeared as the most suitable replacement. Bismuth replaced lead, for instance, in soldering electronic components, in producing tips for pencils without graphite, in cosmetics, in medical chemistry and in many other uses. Bismuth is the heaviest element being simultaneously non toxic and non radioactive. Moreover, bismuth is relatively abundant on Earth.

It is expected that bismuth compounds exhibit the same defect tolerance as the lead ones (v. supra).

Among compounds, bismuth oxides can be investigated. However, although they are very stable, their wide band gap prevents the absorption of a significant portion of the solar light, as reported by S. Ho-Kimura et al, J. Mater. Chem., A 2014, 2, 3948.

Another class of bismuth compounds is the group of chalcogenides, like Bi₂S₃ and AgBiS₂, see for example L. Cademartiri et al., Angew. Chem Int. Ed., 2008, 47, 3814 and M. Bernachea et al., Nature Photonics, 2016, 10, 521. Another kind of compounds can be seen in double perovskites, like Cs₂AgBiBr₆, see for example E. Greul et al., J. Mater. Chem. A, 2017, 5, 19972. All of these materials exhibit a narrow band gap.

Other materials which can be considered for the production of photoactive materials are bismuth chalcohalide materials, showing the general structure MₙEₚX_{q}, where M is a metal, like bismuth, E is a chalcogen, like S, Se and X is a halide, like Cl, Br, I. However, studies on the use of these materials for the production of photoactive structures are quite few. Generally, such materials can be synthesised in good quality crystals, by crystallisation of molten materials, taking place during up to several days (see for example, E. Wlazlak et al., Chem. Comm., 2018, 54, 12133). However, their use for solar energy conversion is limited by the post-growing process of single crystals: their direct growth on conductive substrates, as discussed above, allows only a poor control over the synthetic product, see N. T. Hahn et al., J. Phys. Chem. Lett., 2012, 3, 1571 and D. Tiwari et al., ACS Appl. Ener. Mater., 2019, 2, 3878.

WO2016/161 392 discloses an optoelectronic device, comprising an absorber layer, comprising a composition including a partially oxidised cation, containing a lone 6s² or 5s² pair of electrons halide anion or chalcogenide anion or a combination thereof. A number of chalcohalides is within the scope of this prior art document. However, such materials are synthesised as regularly sized crystals which are applied onto a substrate well-known technique, like depositing a solution and evaporating the solvent or via sublimation. However, as said above, the result is a relatively wide creation of surface defects, which results in a poor efficacy.

Photoactive materials can also be used for manufacturing photoelectrodes, which can be employed in photoelectrochemical devices. An exemplary photoelectrochemical device, which has a wide range of applications, is a photoelectrochemical cell, useful as solar battery or for the artificial photosynthesis.

Other synthetic methods include solution phase approaches, with limited post-synthetic processing (e.g Wlazlak, v. supra) or, like reported by Xu et al., Angew. Chem. Int. Ed., 2018, 57, 2413, synthetic methods yielding solvent dispersible nanoscopic crystals, exhibiting a narrow size distribution and consisting of elongated nanocrystals of either Bi₁₃S₁₈I₂ or Bi₁₉S₂₇I₃, obtained either as nanopowders, requiring polymer assisted processing in order to be dispersible, or as colloidal dispersion, wherein however an almost stoichiometric amount of Al³⁺ cation is necessary to avoid the formation of Bi₂S₃.

Problem of the invention is to propose a process for the synthesis of nanocrystals of metal chalcohalides, having the chemical formula MₙEₚX_{q}, where M is a metal, E is a chalcogen and X is a halogen which overcomes the above drawbacks and which allow to get metal chalcohalides useful for applying them onto a suitable substrate in a uniform and smooth way. This purpose is achieved through a process for the synthesis of nanocrystals of metal chalcohalides, having the chemical formula MₙEₚX_{q}, where M is a metal, E is a chalcogen and X is a halogen or MₙM′_{n′}EₚX_{q′}, where M is a metal, M′ is another metal, E is a chalcogen and X is an halogen, characterised in that the process includes the following steps: a) a precursor of metal M is mixed with a surfactant in a solvent having a boiling point higher than 180° C.; b) the mixture obtained in previous step a) is heated, in order to dissolve the components, until it becomes clear; c) the solution is heated up under inert atmosphere at the desired temperature; d) chalcogen and halogen precursors in a solvent having a boiling point higher than 180° C. are added through injection, while heating the solution obtained in steps a) to c); e) after the reaction time has elapsed, the product is quenched down to room temperature. According to a second aspect, this invention relates to Nanocrystals of metal chalcohalides, having the chemical formula MₙEₚX_{q}, where M is a metal, E is a chalcogen and X is a halogen, characterised in that M is chosen between Bi and Sb, E is chosen between S and Se and X is chosen among Cl, Br and I. According to a third aspect, this invention refers to the use of the nanocrystals of metal chalcohalides, having the chemical formula MₙEₚX_{q} or MₙM′_{n′}EₚX_{q}, where M (and possibly M′) is a metal, E is a chalcogen and X is a halogen, for the production of a photoelectrode active all over the range of the visible light, characterised in that M is chosen between Bi and Sb, if present, M′ is chosen among alkaline metals and group IB metals, E is chosen between S and Se and X is chosen among Cl, Br and I.

Further characteristics and advantages of this invention are anyway more apparent when reading the following detailed description of a preferred embodiment, which is given by way of example only, and with reference annexed to the drawings, wherein:

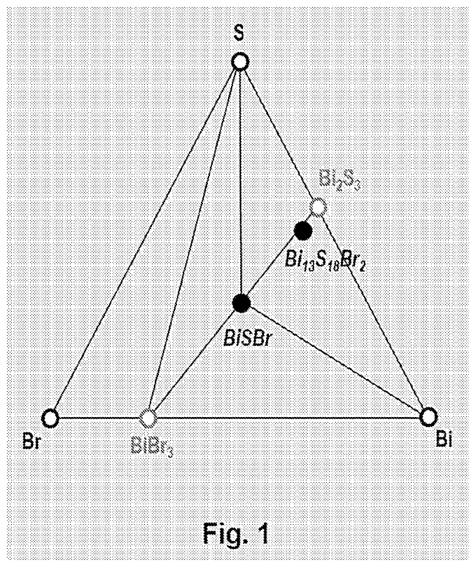

FIG. 1 is a phase diagram of the M-E-X system, where M is Bi, E is S and X is Br;

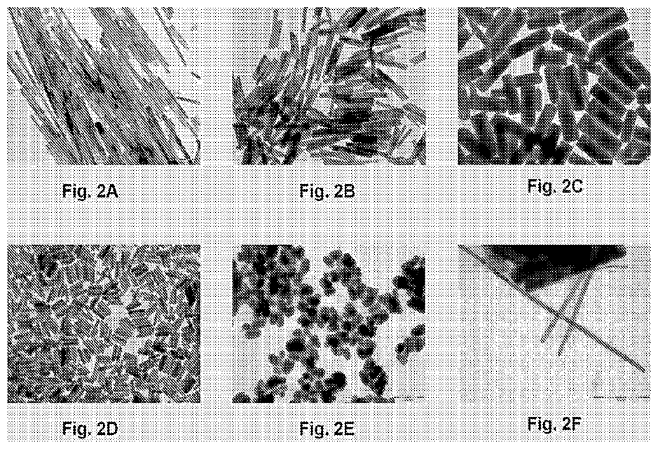

FIGS. 2A-2F are TEM images of phase pure colloidal nanocrystals and respectively refer: FIG. 2A to BisCl, FIG. 2B to BiSBr, FIG. 2C to BiSI, FIG. 2D to Bi₁₃S₁₈Br₂, FIG. 2E to Bi₁₃S₁₈I₂; and FIG. 2F to BiSeBr;

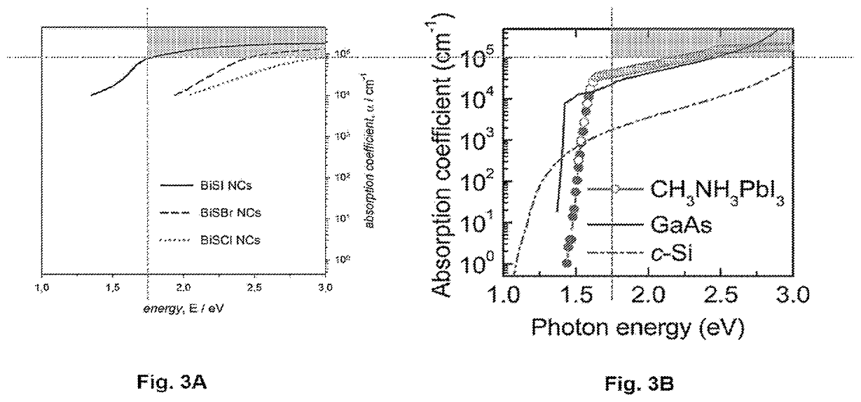

FIG. 3A is a Vis-NIR spectrum of some compounds according to this invention;

FIG. 3B is a Vis-NIR spectrum of some other materials, according to the prior art (from B, J. Phys. Chem. Lett. 2014, 5, 6, 1035-1039);

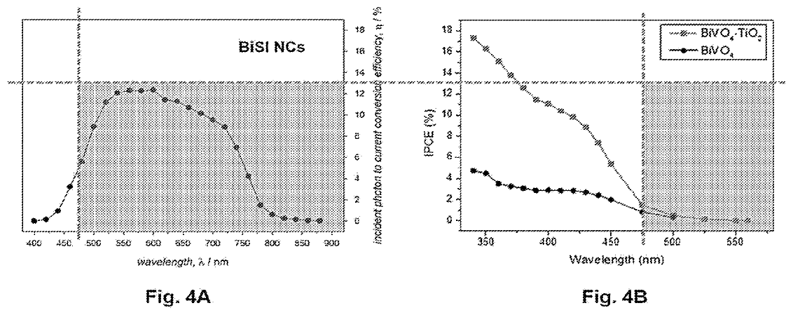

FIG. 4A shows incident photon-to-current conversion efficiency related to an electrode, produced according to this invention;

FIG. 4B shows incident photon-to-current conversion efficiency related to two electrodes produced according to the prior art (from B, J. Mater. Chem. A, 2014, 2, 3948-3953); and

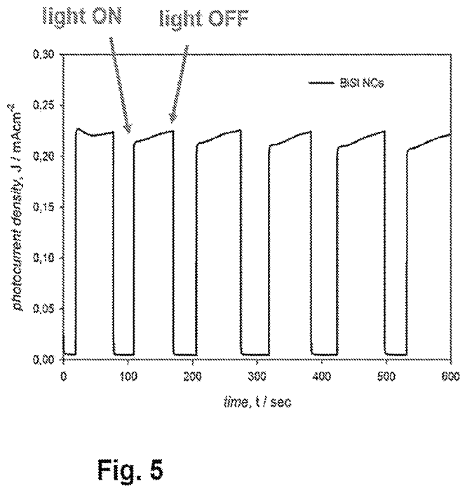

FIG. 5 shows the photocurrent density trend over the time related to an electrode produced according to this invention.

As it has already been seen above, this invention refers to process for the synthesis of nanocrystals of metal a chalcohalides, starting from a precursor of M. According to preferred embodiments of this invention, M is a metal chosen in the group consisting of Bi and Sb. E represents a chalcogen and, according to a preferred embodiment of the invention, is chosen between S and Se. X is a halogen, and is chosen among Cl, Br and I. According to other preferred embodiments of this invention, M can encompass also a second metal, M′, so that the actual formula becomes MₙM′_{n′}EₚX_{q}.

In the first step of the process, a precursor of the metal M, preferably a carboxylic salt, is mixed with a surfactant, in a solvent, having a boiling temperature higher than 180° C., preferably higher than 190° C., higher than 195° C., higher than 200° C., higher than 205° C., higher than 210° C. or higher than 215° C. The solvent can be chosen within the group consisting of: dodecane, tetradecane, hexadecane, octadecane, 1-dodecene, 1-hexadecene, 1-octadecene. Any kind of surfactant can be suitable for the process of this invention. Anionic, cationic, zwitterionic and non-ionic surfactants can be suitable. Among them, a preference is within the group consisting of: quaternary ammonium salts, ammonium lauryl sulphate, undecenoic acid, lauric acid, myristic acid, palmitic acid, stearic acid, linoleic acid, tetradecylphosphonic acid, octadecylphosphonic acid, docusate, perfluoroctanesulphonate, sodium oleate, oleic acid, sodium linoleate, sodium linolenate, cocamidopropyl betaine, phosphatidylserine. The mixture is prepared under stirring, at room temperature. There is no limitation as for metal precursors. Particularly suitable are metal salts, which are widely available. Example of metal salts can be halides, like chlorides, bromides, iodides; nitrates; nitrites; carbonates; carboxylates. Among carboxylates, low molecular weight carboxylates are preferred, like formates, acetates, propionates, butyrates and pentanoates are preferred, which can be easily removed.

The mixture obtained in the first step is heated, in order to get a clear solution. Heating ranges between 90° C. and the solvent boiling point, preferably between 10° and 170° C., more preferably between 10° and 150° C.

When the solution is completely clear, the solution is cooled down preferably between 7° and 120° C., more preferably between 8° and 90° C., and then subjected to repeated cycles of vacuum application and purging with an inert gas. The inert atmosphere is kept through the use of the usual inert gases, like nitrogen, helium, carbon dioxide or argon. This treatment can be repeated more than once, in order to deareate the solution and to remove the eventual water and acids which form upon dissolution of the bismuth precursor. The temperature is then raised up between 15° and 210° C., typically at 180° C.

The next step is the addition of chalcogen and halogen precursors. The addition takes place through a direct injection, by using a conventional syringe or any other suitable tool, which is per se well known. The best results are obtained when chalcogen and halogen precursors are co-injected. As chalcogen precursors, there is no particular limitation. Any inorganic or organic sulfide is virtually suitable. Organic sulfides are particularly suitable; among organic sulfides, silicon based sulfides are preferred, particularly preferred is bis(trimethylsilyl) sulfide. As halide precursors, there is no particular limit. Inorganic and organic halides can be used. Among the organic halides, acyl and aryl halides are particularly suitable, especially low acyl halides, the excess of which can be easily removed. Examples are acetyl, propionyl, butyroyl or benzoyl halides. Among the organic halides, silicon based halides are also preferred, trimethylsilylhalides being the most preferred.

The final quenching of the product solution can be reached through any technique, which is at the reach of the skilled person. Therefore, ice baths, liquid nitrogen, natural cooling down are all admissible, according to the circumstances.

According to this invention, also nanocrystals obtained through the above process, having the general formula MₙEₚX_{q}, where M is a metal, E is a chalcogen and X is a halide, are provided. Pure orthorombic or hexagonal nanocrystals can generally be obtained.

Preferably, M is Bi or Sb; E is S or Se; and X is Cl, Br or I. Examples of compounds according to this invention have the following formulae: BiSBr, Bi₁₃S₁₈Br₂, BiSeBr, BiSeI, BisCl, BiSI, Bi₁₃S₁₈I₂. Moreover, a completely unknown BisCl polymorph can be synthesised. In case M encompasses also M′, the latter is chosen among an alkaline metal and a group IB metal. M′ is preferably Cs, Cu or Ag.

The above referenced nanocrystalline compounds are colloidally stable and can withstand at least up to 250° C., so that they are particularly useful for the preparation of inks, which can be used for their application by coating them, in a way per se known, onto a substrate. In principle, also pastes and composites can be obtained. Moreover, it is to pay attention to the fact that the compounds obtained through the process according to this invention are photoactive substances, which can be used for applications in this field, combining these features with the capability to be spread as an ink. This can result in the possibility of creating robust, thin films, with reduced roughness and no lacks on the surface under room conditions, thus resulting in smooth surfaces. In this way, by spreading these compounds onto a substrate and removing the solvent, a robust thin film can be got, which has photoactive properties, so that a photoelectrode can be easily obtained, with very good surface properties and with a smooth, uniform surface, which allows very good performance, without transient areas or areas where the lack of the film can result problems. Such photoelectrodes can have application in in photochemistry. Among such applications, one of the preferred ones is for the artificial photosynthesis and another on for solar fuels, particularly including H₂.

The amenability to both surface chemistry modification and thermal annealing of the metal chalcohalides enabled the nanocrystal processing into stable, insoluble solids that can be deposited on various substrates bare (such as glasses, conductive glasses, stainless steel, and silicon wafers). Such solids were fabricated by a three step method comprising: i) the spin casting of the nanocrystals previously exchanged in the solution phase with ligands, such as the corresponding halide salt of a quaternary ammonium cation; ii) the solid phase exchange of the ligands, such as the corresponding methylammonium halide salt, then followed by rinsing with a polar solvent, such dimethylformamide; iii) the thermal as annealing at 180° C. All the steps can be repeated up to eight times to fill cracks and voids due to the displacement of the bulky ligands and to the eventual close packing of the nanocrystals induced by the annealing process. This layer-by-layer process can be conducted at standard laboratory conditions, without control on either the ambient temperature or humidity.

This invention is now clarified through some preparations. Examples, which are reported as examples only, with no limitation to the scope of this invention, which is defined only by the appended claims.

### Preparation Example 1

This example refers to the preparation of BiSBr.

0.3 mmol (120 mg) of Bi acetate and 3 mmol (850 mg) of oleic acid were mixed in 3 g of 1-octadecene. The mixture was vigorously stirred and deaerated, through repeated cycles of vacuum application and purging with nitrogen at about 80° C. The mixture was then heated to above 100° C., to dissolve Bi acetate, until the solution became colourless and optically transparent, suggesting the complete formation of bismuth (III)-oleate complex(es). The solution was cooled at 80° C. and repeatedly subjected to vacuum, in the attempt of removing acetic acid possibly released upon the bismuth (III)-oleate complex(es) formation. The solution was then heated again under nitrogen flow, while the temperature stabilised at 180° C.

At this point, half equivalent of the sulfur precursor (bis(trimethylsilyl) sulfide; 0.15 mmol, 32 μl) and one equivalent of the bromine precursor (benzoylbromide; 0.3 mmol, 35 μl) in 2 ml of 1-octadecene were swiftly co-injected. The reaction was allowed to proceed for 15 minutes, then the heating mantle was removed and the resulting colloidal dispersion was forced to room temperature, in an ice bath. After the synthesis, the reaction mixture was transferred to a nitrogen-filled glove box. The crude product was centrifuged without antisolvents, the supernatant was discarded, and the resulting pellet was redispersed in anhydrous toluene and stored in a nitrogen-filled glove-box for further use. Further purification by precipitation/redispersion of the nanocrystals compromised their colloidal stability and were not suitable for the long-term storage; this issue was addressed by post-synthesis ligand exchange reactions. Effective tuning of the BiSBr NC morphology can be achieved, by employing alternative sulfur and bromine precursors, such as substituted thioureas, like N, N,N′,N′-tetramethylthiourea, and trimethylsilylbromide, respectively, in analogous synthetic conditions.

The chemical species at the surface of as-synthesised nanocrystals were replaced by ligand exchange reactions at room temperature, either in solution phase or in solid phase. The oleyl-based ligands, coming from the synthetic procedure, were exchanged for either alkylthiols, like 1-dodecanethiol, or quaternary ammonium halide salts, like dimethyldidodecylammonium halides in toluene and for methylammonium halide salts in dimethylformamide. The ligand exchange reactions were carried out by adding aliquots of 100 mM solutions of the replacing ligands, in either toluene or dimethylformamide, up to one the dispersion the ligand per Bi atom; was centrifuged, supernatant discarded, and the resulting nanocrystal pellet redispersed in the solvent used for the replacing ligand. Solid films of the nanocrystals were deposited onto substrates (glass, silicon wafer, transparent conductive oxides, stainless steel) by spin casting toluene dispersions of the nanocrystals coordinated by quaternary ammonium halide salts ligands; the as-casted nanocrystals were further ligand exchanged with ammonium halide in dimethylformamide, then the nanocrystal solid was rinsed with dimethylformamide; the deposition cycle can be repeated up to eight times; an annealing step at 180° C. can be applied.

### Preparation Example 2

The synthesis of Bi₁₃S₁₈Br₂ nanocrystals was accomplished, by halving the amount of benzoylbromide (0.15 mmol) co-injected with bis(trimethylsilyl) sulfide in a 1-octadecene solution of Bi-carboxylates, as hereinabove described.

Analogous reaction conditions were also used when using other chalcogen and halogen precursors, such as 1,1-dimethyl-2-selenourea, benzoylchloride, and benzoyliodide, which were used to synthesise BiSeBr, BisCl, BiSI, and Bi₁₃S₁₈I₂ nanocrystals.

1,1-dimethyl-2-selenourea was used as Se precursor; since it is barely soluble in 1-octadecene, it was used in a heterogeneous mixture with benzoylbromide, to synthesise BiSeBr nanocrystals.

Benzoylchloride was used to synthesise BisCl nanocrystals; we note that the lower reactivity of benzoylchloride compared to benzoylbromide required the use of 0.5 mmol, to obtain BisCl nanocrystals from 0.3 mmol of Bi-carboxylates (compared to the 0.3 mmol of benzoylbromide for BiSBr nanocrystal synthesis).

Benzoyliodide was used in the synthesis of BiSI and Bi₁₃S₁₈I₂ nanocrystals; it was obtained by reacting benzoylchloride with an excess (1.5 equivalents) of sodium iodide at 80° C. for five hours. The higher reactivity of benzoyliodide compared to benzoylbromide required the use of 0.15 mmol, to obtain BiSI from 0.3 mmol of Bi-carboxylates (whereas 0.05 mmol were used to obtain Bi₁₃S₁₈I₂ nanocrystals, compared to the 0.15 mmol of benzoylbromide for the synthesis of Bi₁₃S₁₈Br₂ nanocrystals).

Some characterizations are now shown, with reference to the annexed pictures.

A phase diagram of the MEX system is shown in FIG. 1. It shows the MₙEₚX_{q} compounds which can at least theoretically be obtained through the process according to this invention. The shown system includes Bi, S and Br, but diagrams with other M, E and X components are possible.

FIGS. 2A-2F show TEM micrographs. Transmission electron microscopy were used to get information about the morphology of these nanocrystals. TEM images were recorded with a Jeol Jem 1011 microscope, operated at an accelerating voltage of 100 kV. Samples for analysis were prepared by dropping from a dispersion of nanocrystals onto carbon-coated Cu grids and then allowing the solvent to evaporate in a vapour controlled environment. Longitudinal and lateral sizes were determined the by statistical analysis of TEM images of several hundreds of nanocrystals with the Image] software. In particular FIG. 2A refers to BisCl, FIG. 2B to BiSBr, FIG. 2C to BiSI, FIG. 2D to Bi₁₃S₁₈Br₂, FIG. 2E to Bi₁₃S₁₈I₂ and FIG. 2F to BiSeBr.

FIGS. 3A and 3B show a comparison between the compounds obtained through the process according to this invention (FIG. 3A) and some photoactive systems of the state of the art (FIG. 3B). The comparison shows that the effect of absorbing electromagnetic radiations by the inventive systems (FIG. 3A), like visible light, is still higher at the visible spectral range than with the well known systems (FIG. 3B), so that the inventive compounds are more versatile, exhibiting a high light absorption coefficient. It is to be stressed that e the replacement of lead with bismuth is not only advantageous because replaces a toxic component with a harmless one, but also results in a higher effect of absorbing electromagnetic radiations like visible light than the compounds containing lead exhibited: compounds containing lead could absorb only a part of the visible light (furthermore without spectral modulation), while compounds containing bismuth can absorb all visible light and a part of the infrared radiation.

FIGS. 4A and 4B show a comparison of the incident photon to current conversion energy for the inventive systems (FIG. 4A) and for some prior art compounds (FIG. 4B). The comparison shows a very wide range of high harvest of light with respect to prior systems, which show in turn a much lower performance. Furthermore, the inventive systems allow to produce current for a wider range of wavelength, therefore taking advantage of more conditions of light and being more independent of the particular environmental conditions.

FIG. 5 shows the photocurrent density over the time in the inventive systems. Under solar simulated illumination, a photocurrent density of the order of the mA/cm² at a 0.25 V bias could be extracted for several minutes, with a good reproducibility between different nanocrystalline solids.

This invention allows to get semiconductor nanomaterials, starting from metals with reduced toxicity, with relatively wide availability and with limited market prices. Even materials which were per se already been disclosed, have been obtained in a colloidal form, which is completely new and not at the immediate reach of the skilled person, through the process according to this invention. A new manufacturing way has been therefore made available for photoelectrochemical cells and new horizons open for batteries for solar and artificial photosynthetic processes.

Anyway, it is understood that the invention should not be considered limited to the particular embodiments illustrated above, which make up only exemplary embodiments thereof, but that more variants are possible, all under reach of the skilled person, without departing from the scope of the invention itself, as defined by the appended claims.

1. Process for the synthesis of nanocrystals of metal chalcohalides, having the chemical formula MₙEₚX_{q}, where M is a metal, E is a chalcogen and X is a halogen or MₙM′_{n′}EₚX_{q′}, where M is a metal, M′ is another metal, E is a chalcogen and X is an halogen, characterised in that the process includes the following steps: a) a precursor of metal M is mixed with a surfactant in a solvent having a boiling point higher than 180° C.; b) the mixture obtained in previous step a) is heated, in order to dissolve the components, until it becomes clear; c) the solution is heated up under inert atmosphere at the desired temperature; d) chalcogen and halogen precursors in a solvent having a boiling point higher than 180° C. are added through injection, while heating the solution obtained in steps a) to c); e) after the reaction time has elapsed, the product is quenched down to room temperature.

2. Process as claimed in claim 1, characterised in that, when the solution is completely clear after the step c), the solution is cooled down between 7° and 120° C. and then subjected to repeated cycles of vacuum application and purging with an inert gas.

3. Process as claimed in claim 1, characterised in that said solvent is chosen within the group consisting of: dodecane, tetradecane, hexadecane, octadecane, 1-dodecene, 1-hexadecene, 1-octadecene.

4. Process as claimed in claim 1, characterised in that said surfactant is chosen within the group consisting of: quaternary ammonium salts, ammonium lauryl sulphate, undecenoic acid, lauric acid, myristic acid, palmitic acid, stearic acid, linoleic acid, tetradecylphosphonic acid, octadecylphosphonic acid, docusate, perfluoroctanesulphonate, sodium oleate, oleic acid, sodium linoleate, sodium linolenate, cocamidopropyl betaine, phosphatidylserine.

5. Process as claimed in claim 1, characterised in that the metal precursor is chosen among halides, like chlorides, bromides, iodides; nitrates; nitrites; carbonates; carboxylates.

6. Process as claimed in claim 5, wherein the precursor is a carboxylate, characterised in that it is chosen among formates, acetates, propionates, butyrates and pentanoates are preferred.

7. Process as claimed in claim 1, characterised in that as chalcogen precursors an inorganic or an organic sulfide is used.

8. Process as claimed in claim 7, characterised in that an organic sulfide is chosen within the group consisting of silicon based sulfides.

9. Process as claimed in claim 1, characterised in that as halide precursors an organic halide is chosen within the group consisting of: acyl and silicon based halides.

10. Process as claimed in claim 9, characterised in that the halide is chosen within the group consisting of acetyl, propionyl, butirroyl or benzoyl halides.

11. Nanocrystals of metal chalcohalides, having the chemical formula MₙEₚX_{q}, where M is a metal, E is a chalcogen and X is a halogen, characterised in that M is chosen between Bi and Sb, E is chosen between S and Se and X is chosen among Cl, Br and I.

12. Nanocrystals as claimed in claim 11, characterised in that they are chosen within the group consisting of BiSBr, Bi₁₃S₁₈Br₂, BiSeBr, BiSeI, BiSCl, BiSI, Bi₁₃S₁₈I₂, Bi₁₃S₁₈Br₂, SbSBr, SbSI, SbSeBr, SbSeI.

13. Nanocrystals as claimed in claim 11, characterised in that M encompasses also a second metal, M′, so that the actual formula is MₙM′_{n′}EₚX_{q}.

14. Nanocrystals as claimed in claim 13, characterised in that M′ is chosen among alkaline metals and group IB metals.

15. Use of the nanocrystals of metal chalcohalides, having the chemical formula MₙEₚX_{q} or MₙM′_{n′}EₚX_{q}, where M (and possibly M′) is a metal, E is a chalcogen and X is a halogen, for the production of a photoelectrode active all over the range of the visible light, characterised in that M is chosen between Bi and Sb, if present, M′ is chosen among alkaline metals and group IB metals, E is chosen between S and Se and X is chosen among Cl, Br and I.
